(19) United States
(12) Patent Application Publication
(10) Pub. No.: US 2015/0217242 A1
(43) Pub. Date: Aug. 6, 2015

(54) TOTALLY SCREWED STAGGERED ROTOR BARS FOR FEED AND INDUSTRIAL MIXER

(71) Applicant: Celso Luis CASALE, Sao Carlos (BR)

(72) Inventor: Celso Luis CASALE, Sao Carlos (BR)

(21) Appl. No.: 14/523,212

(22) Filed: Oct. 24, 2014

(30) Foreign Application Priority Data
Feb. 4, 2014 (BR) 10 2014 002756 4

(51) Int. Cl. B01F 7/00

(52) U.S. Cl. CPC B01F 7/00016; B01F 7/00033; B01F 7/00058

(57) ABSTRACT

This patent application is related to a TOTALLY SCREWED STAGGERED ROTOR BARS FOR FEED AND INDUSTRIAL MIXER, used in the cattle raising sector, more specifically in animal husbandry for meat production, consisting of a rotor divided into three segments staggered at 40° to each other, and each one having three pairs of arms (9), comprised by a tube (2) with flanges (6) secured by weld, supporting the beater arms (9), considering that each end thereof has the format of an arc (10) for fitting to the body of the tube (2) and a base (11) for supporting the lateral (12) of the other arm (9).

### FIELD OF THE INVENTION

The present invention relates to a totally screwed staggered rotor bars for feed and industrial mixer, used in the cattle raising sector, more specifically in intensive animal husbandry for meat production.

### STATE OF THE ART

As it is known, the rotor is the main element of feed mixers used in the mixture of nutritional diets for livestock. The mixture provided by the rotor influences directly on weight gain and food efficiency, reducing the occurrence of metabolic disorders to the animals.

During on-site tests with “rotor-type” mixers, it was observed that the system did not operate satisfactorily with certain types of components, sometimes excessively forcing the mechanical components of the equipment, with successive breakdowns and at other times not producing a mixture of quality. In this regard, we may mention the rotors demonstrated by patent documents U.S. Pat. No. 4,506,990, U.S. Pat. No. 4,597,672, and U.S. Pat. No. 4,741,625.

A common problem, and of difficult resolution, was the incapacity of the rotor-type mixer in providing a good mixture when mixing chopped grasses or “panicum” grass into a diet in which the main bulk is the silage of corn or sorghum. The chopped green product tended to concentrate in the center of the rotor with straight and parallel bars, restraining the mixture with the other components. Therefore, after several alternative designs and many hours of testing, solution is given to the problems presented by rotor-type mixers, with the application of the constructive design described in patent document BR 20 2012 033309 6, held by the applicant of the invention proposed herein.

However, with new research and development, it was possible to create a new arrangement for securing beater arms to rotor for feed mixers, thus making the product more efficient regarding its mechanics, resistance of the suite, weight, and productive efficiency.

The totally screwed staggered rotor bars for feed and industrial mixer proposed herein consists of beater arms manufactured in steel with the purpose of reducing the dragging of material (feed); axis provided with flanges for securing the beater arms; securing of three segments of beater arms, staggered in 40° between each of them, and secured by bolts in the same flange, thus reducing the number of parts; the beater arms have constructive design that allows the three arms composing the segment to provide mutual support, thus increasing the rotor resistance. This arrangement allows for a reduction of the weight of the rotor suite and the frontal contact with the material deposited into the cart (feed), mixing in a short period of time the elements composing the feed, so that the mixture is homogeneous.

### OBJECTIVE OF THE INVENTION

The totally screwed staggered rotor bars for feed and industrial mixer has been designed with the main purpose of improving the mechanics, resistance, weight, and productive efficiency of the device in relation to what is currently available in the market, providing a totally screwed staggered rotor bars for feed and industrial mixer with beater arms manufactured in sheets, with the purpose of reducing the dragging of material (feed); axis provided with flanges for securing the beater arms; Securing of three segments of beater arms, staggered in 40° between each of them, and secured by bolts in the same flange, reducing the number of components; the beater arms have constructive design that allows the three arms composing the segment to provide mutual support, thus increasing the rotor resistance. The arms proposed by this patent application reduce the weight of the rotor and the frontal contact area with the mixture (feed), consequently reducing the consumption of fuel of the equipment by approximately 15%, as well as the manufacturing time by 60% in relation to what is current available.

### BRIEF DESCRIPTION OF THE FIGURES

FIG. 1 is a front view of the rotor duly assembled, where the totally screwed staggered rotor bars for feed and industrial mixer proposed can be observed.

FIG. 2 is a front view of the rotor duly assembled, showing the dotted lines indicating the details of its construction.

FIG. 3 is the left side view of rotor duly assembled.

FIG. 4 is the right side view of the rotor duly assembled.

FIG. 5 is the front view of the tube with the flanges.

FIG. 6 is the isometric view of the tube with the flanges.

FIG. 7 is a detailed view of the tube with the flange.

FIG. 8 is the isometric view of the beater arm.

FIG. 9 is the isometric view of the beater arm, showing the dotted lines indicating the beater fitting.

FIG. 10 is a detailed view of the interconnection of the beater arm to the bearing.

FIG. 11 is a detailed view of the interconnection of the arm to the beater.

### DETAILED DESCRIPTION OF THE INVENTION

The description of the invention is made at its preferred modality, based on the figures attached hereto.

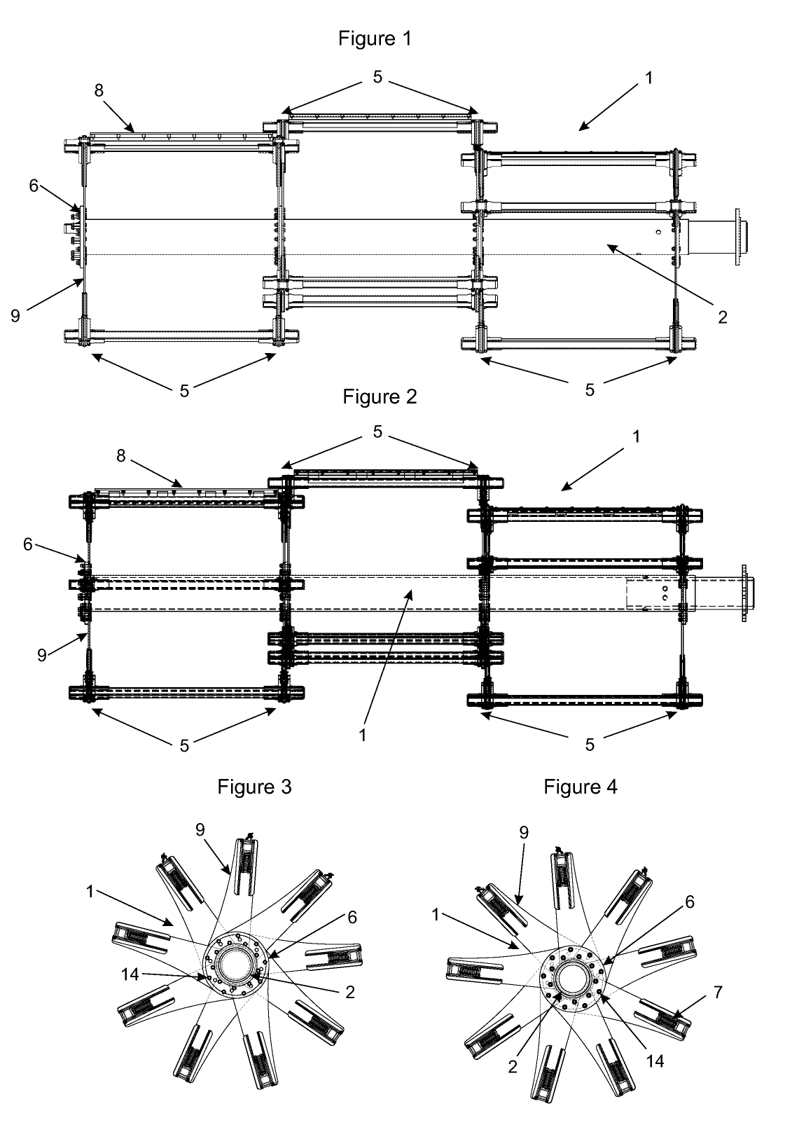

The rotor, as it may be observed in FIGS. 1 to 4, is divided into three segments staggered at 40° between each other, each one heaving three pairs of arms (9).

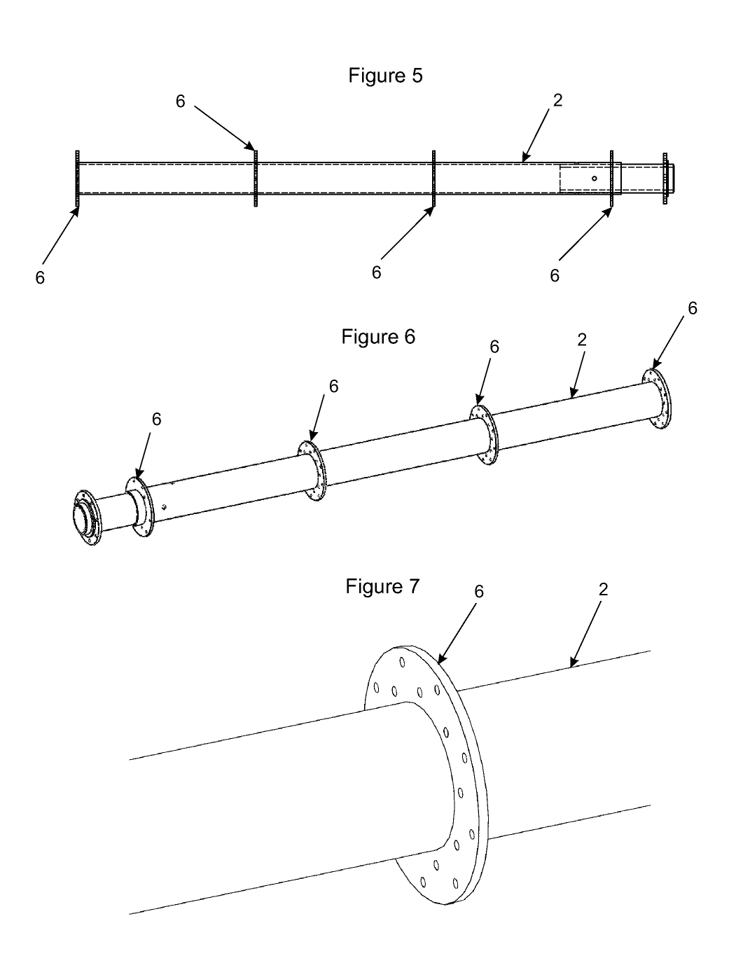

Such rotor is made of a tube (2) of steel, bi-supported in bearings secured to the apparatus cart, provided with flanges (6) secured by weld, which support the beater arms (9). Such tube (2) is shown in FIGS. 5 to 7.

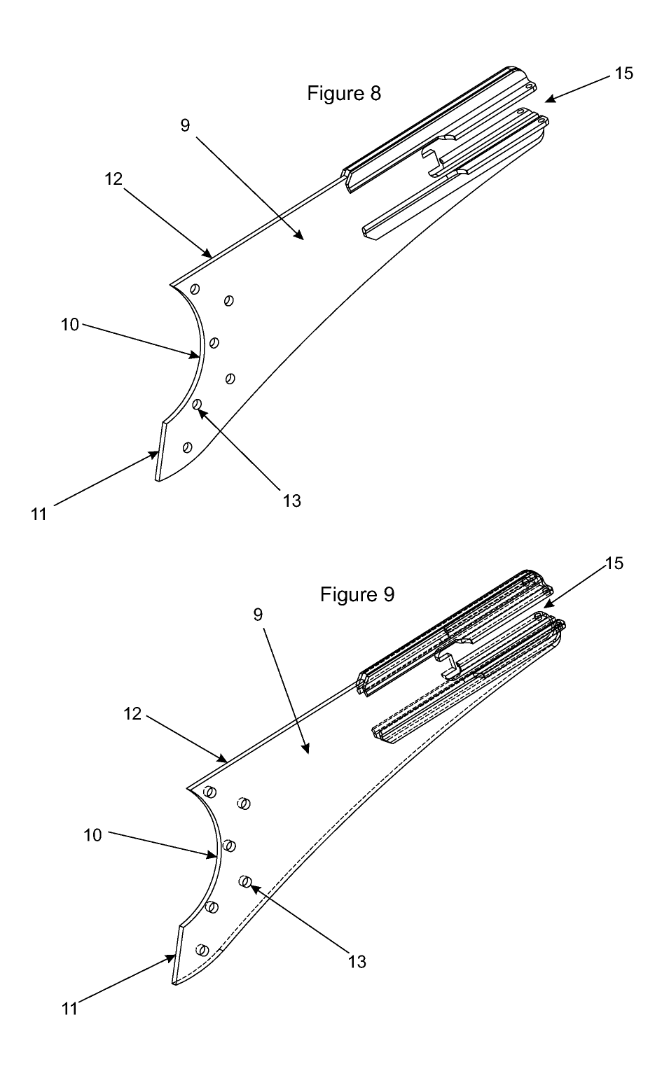

The beater arms (9) are made of steel sheets, with one of its ends having the shape of an arc (10) for fitting the body of the tube (2) and a base (11) for support in the lateral (12) of the other arm (9). Such end has holes (13) for securing the bolts and nuts (14) to the flanges (6). The other end, with a fitting in the shape of a rectangular slot (15) for the beaters. The arms (9), according to their constructive design, reduce the dragging of the material (feed). These arms are shown in FIGS. 8 and 9.

The securing of the arms (9) shares the same flange (6) of the internal segments, reducing the number of components of the rotor.

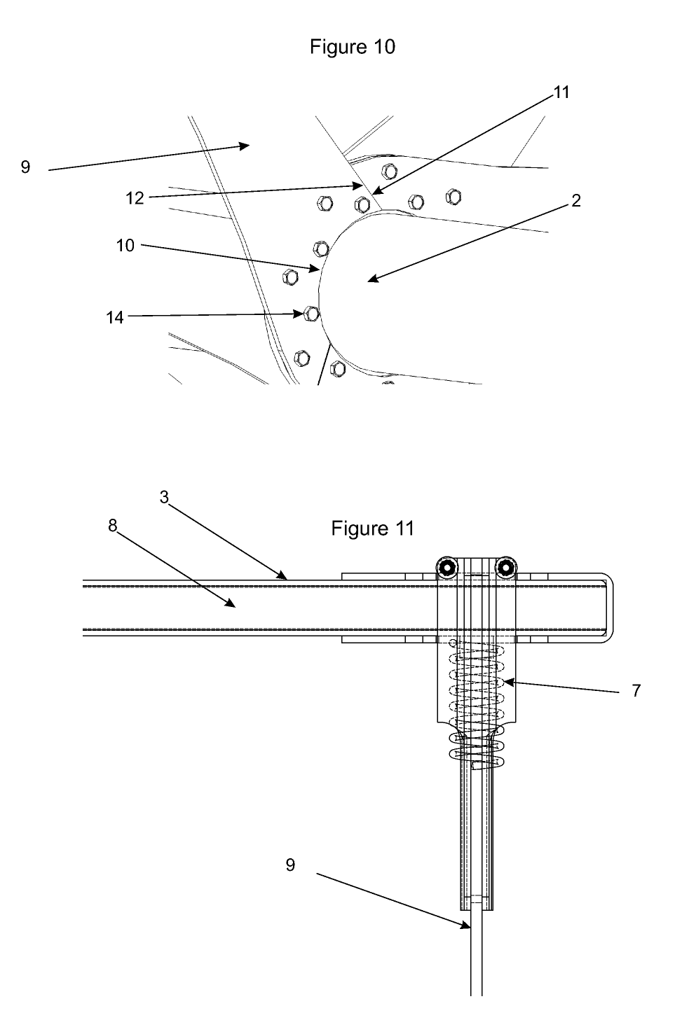

The constructive arrangement of the arms (9) allows that the three arms (9) composing the sides of the segment support each other, increasing the resistance of the apparatus, as of FIG. 10.

The bars (8) of the rotor (1) are secured at the end of the arms (9), as illustrated by FIG. 11, considering that all bars have a damping system, provided by springs (7), with the purpose of avoiding the rotor (1) from interlocking, in case of inappropriate arrangement of material (feed) in the cart.

At the end of three of such bars (8), one in each segment, nylon sheets (3) are secured with the purpose of scrapping the bottom of the cart.

The arms as described in this patent application reduce the weight of the rotor and the frontal contact area with the mixture (feed), reducing the consumption of fuel of the equipment by approximately 15%, as well as the manufacturing time by 60% in comparison to what is currently available.

1. TOTALLY SCREWED STAGGERED ROTOR BARS FOR FEED AND INDUSTRIAL MIXER, comprising a rotor divided in three segments staggered at 40° between each other, each one having three pairs of arms (9), characterized by a tube (2) of steel provided with flanges (6) secured by weld, supporting the beater arms (9) built of steel sheets, with one of its ends having the shape of an arc (10) for fitting to the body of the tube (2) and a base (11) for supporting the lateral (12) of the other arm (9).

2. TOTALLY SCREWED STAGGERED ROTOR BARS FOR FEED AND INDUSTRIAL MIXER, according claim 1, characterized by the three arms (9) composing the sides of the segments supporting each other.

3. TOTALLY SCREWED STAGGERED ROTOR BARS FOR FEED AND INDUSTRIAL MIXER, according claim 1, characterized by the securing of the arms (9) sharing the same flange (6) of the internal segments.

4. TOTALLY SCREWED STAGGERED ROTOR BARS FOR FEED AND INDUSTRIAL MIXER, according claim 1, characterized by the arm (9) having holes (13) for securing by bolts and nuts (14) to the flanges (6).

5. TOTALLY SCREWED STAGGERED ROTOR BARS FOR FEED AND INDUSTRIAL MIXER, according claim 1, characterized by the arm (9) having a fitting in the shape of a rectangular slot (15) for the beaters (8).

6. TOTALLY SCREWED STAGGERED ROTOR BARS FOR FEED AND INDUSTRIAL MIXER, according claim 1, characterized by the arms (9) securing bars (8) of the rotor (1), considering that such bars have a damping system provided by springs (7).
